(19) United States
(12) Patent Application Publication
(10) Pub. No.: US 2026/0244512 A1
(43) Pub. Date: Aug. 20, 2026

(54) METHOD AND SYSTEM FOR CONTROLLING RESOURCE USAGE OF CONTAINER PODS

(71) Applicant: Verizon Patent and Licensing Inc., Basking Ridge, NJ (US)

(72) Inventors: Vijayaraghavan Ramalingam, Tamil Nadu (IN); Vijai Ekambaram, Chennai (IN); Mallampalli Nagarjuna, Telangana (IN); Abhimanyu Bhardwaj, Telangana (IN); Sanjay Ravi Vyas, Hyderabad (IN)

(21) Appl. No.: 19/058,271

(22) Filed: Feb. 20, 2025

(51) Int. Cl. G06F 9/50; G06N 20/00

(52) U.S. Cl. CPC G06F 9/5077; G06F 9/5083; G06N 20/00

(57) ABSTRACT

One or more computing devices, systems, and/or methods are provided. In some examples, traffic directed to a first container pod may be identified. Traffic classifications for the traffic may be determined. Each traffic classification may be indicative of whether a subset of the traffic is user activity traffic or non-user activity traffic. One or more traffic metrics associated with the first container pod may be determined. A resource usage parameter associated with the first container pod may be controlled based upon the one or more traffic metrics.

### BACKGROUND

A container orchestration platform manages deployment, scaling and/or maintenance of containerized applications across a cluster of computers. The container orchestration platform may comprise a control plane that oversees the cluster, manages computers of the cluster, and/or handles scheduling associated with the cluster.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for controlling resource usage of container pods, according to some embodiments.

FIG. 1B is a diagram illustrating an example system for controlling resource usage of container pods, where a trained traffic classification model is generated for determining traffic classifications of traffic, according to some embodiments.

FIG. 1C is a diagram illustrating an example system for controlling resource usage of container pods, where training data to provide to a model training pipeline is generated, according to some embodiments.

FIG. 1D is a diagram illustrating an example system for controlling resource usage of container pods, where operations of a model training pipeline are performed to generate a trained traffic classification model, according to some embodiments.

FIG. 1E is a diagram illustrating an example system for controlling resource usage of container pods, according to some embodiments.

FIG. 1F is a diagram illustrating an example system for controlling resource usage of container pods, where a recommendation engine determines one or more recommendations associated with a first container pod, according to some embodiments.

FIG. 1G illustrates a data structure comprising logged data collected by a data collector, according to some embodiments.

FIG. 1H illustrates a data structure comprising at least some of a structured data file generated by a traffic data collection module, according to some embodiments.

FIG. 1I illustrates a program run by a log data parser to generate a structured data file, according to some embodiments.

FIG. 1J illustrates programs run by a data pre-processing module to generate training data, according to some embodiments.

FIG. 2 is a flow chart illustrating an example method for controlling resource usage of container pods, according to some embodiments.

FIG. 3 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for controlling resource usage of container pods are provided. Traffic directed to a first container pod may be identified by a traffic monitoring module. A traffic classification module may be used to determine traffic classifications, each of which may indicate whether a subset of the traffic is user activity traffic or non-user activity traffic. A metrics monitoring module may be used to determine one or more traffic metrics associated with the first container pod based upon the traffic classifications. A resource usage control module may control a resource usage parameter associated with the first container pod based upon the one or more traffic metrics.

The one or more traffic metrics determined by the metrics monitoring module may comprise user activity metrics associated with the first container pod at various times. A user activity metric may be indicative of a measure of user activity traffic (e.g., traffic classified as being user activity traffic by the traffic classification module). A recommendation engine of the resource usage control module may perform a time-series analysis on the user activity metrics to determine user activity patterns associated with the first container pod, such as a pod idle period, a pod active period, and/or a traffic spike period. The recommendation engine may use the user activity patterns to generate recommendations, such as a recommendation to set the resource usage parameter to a pod idle value for the pod idle period (to scale down replicas of the first container pod during the pod idle period, for example), a recommendation to set the resource usage parameter to a pod active value for the pod active period (to scale up replicas of the first container pod during the pod active period, for example), etc. A scaling engine may control the resource usage parameter (to optimize resource usage associated with the first container pod, for example) based upon the recommendations.

Some systems may attempt to control resource usage associated with a container pod without classifying traffic as user activity traffic or non-user activity traffic. Such systems may be unable to accurately detect pod idle periods due to non-user activity traffic (e.g., health check traffic, liveness check traffic, metrics check traffic, dependency check traffic, etc.) being interspersed throughout the pod idle periods. For example, such systems may incorrectly determine that the first container pod is in the pod active period based upon detecting non-user activity traffic directed to the first container pod, which may create the illusion that the first container pod is busy even during times where there is little to no user activity traffic directed to the first container pod. Since such systems are not able to distinguish between user activity traffic (e.g., true workload activity) and non-user activity traffic (e.g., operational checks), they may not be able to identify pod idle periods (e.g., periods of time with little to no user activity), and thus may waste resources by over-provisioning the first container pod during the pod idle periods. In accordance with some embodiments herein, using the traffic classification module to determine whether traffic is user activity traffic or non-user activity traffic enables the determination of user activity metrics, which may be used to more accurately determine pod idle periods (that may include times in which non-user activity traffic is directed to the first container pod, for example), thereby enabling the resource usage control module to more effectively control (e.g., optimize and/or reduce) an amount of resources consumed by the first container pod.

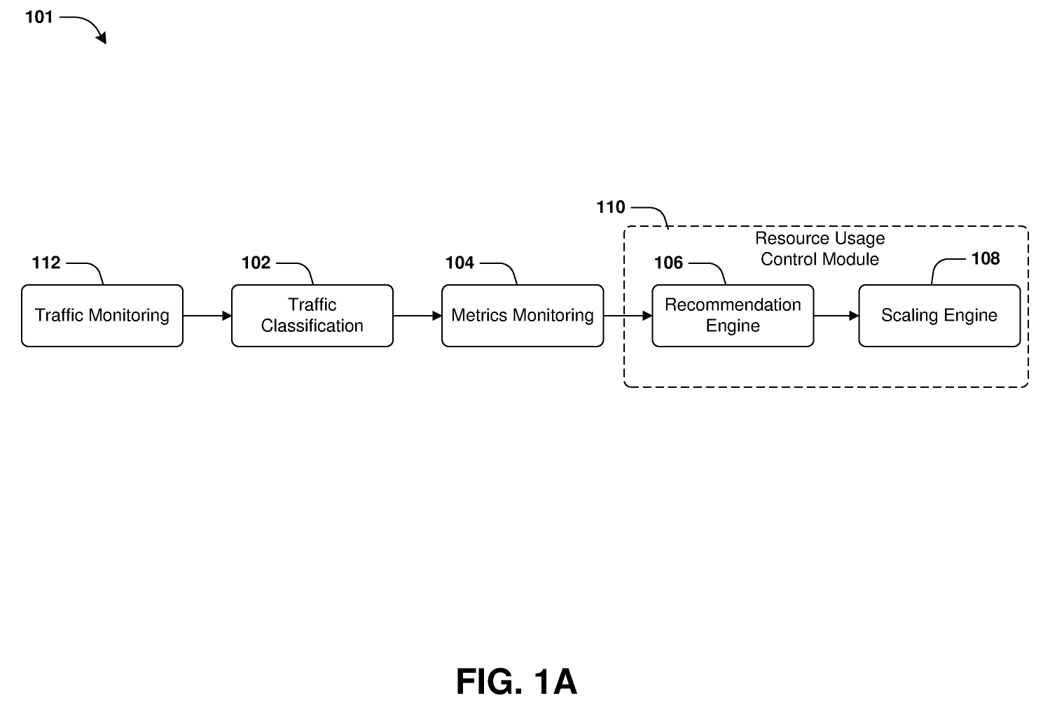

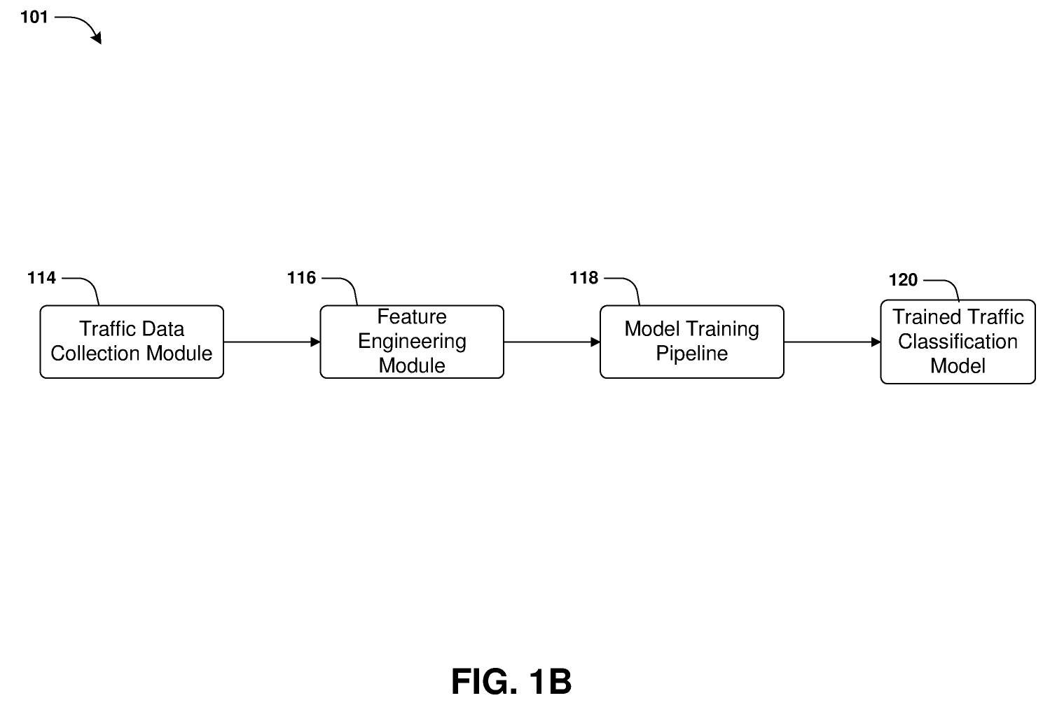

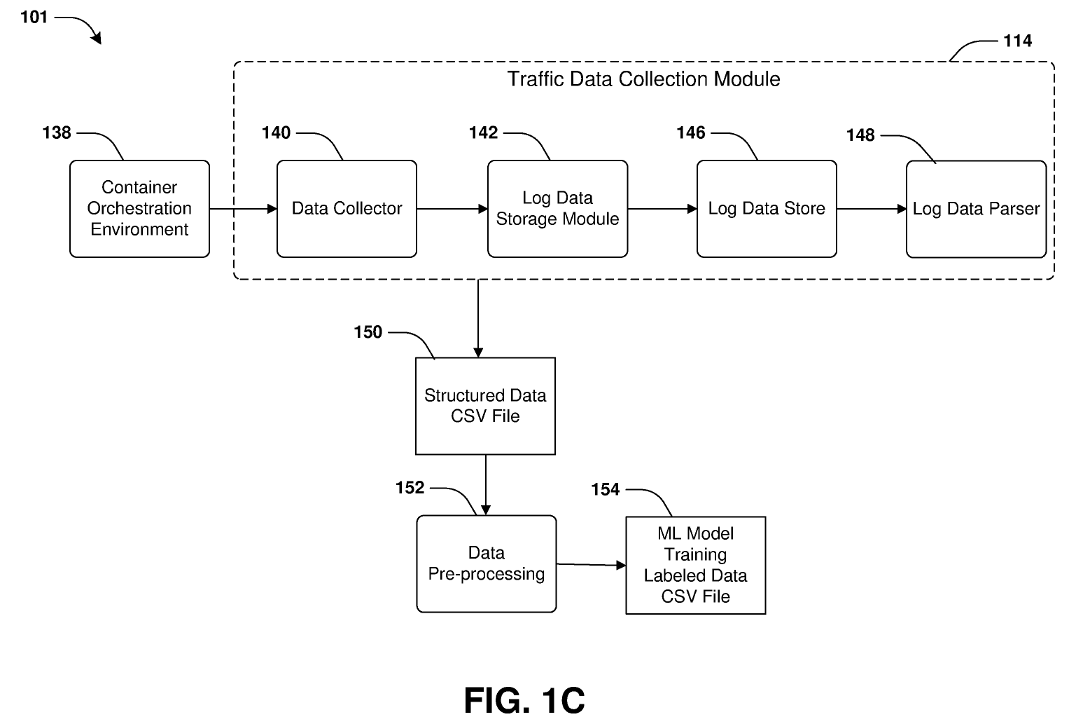

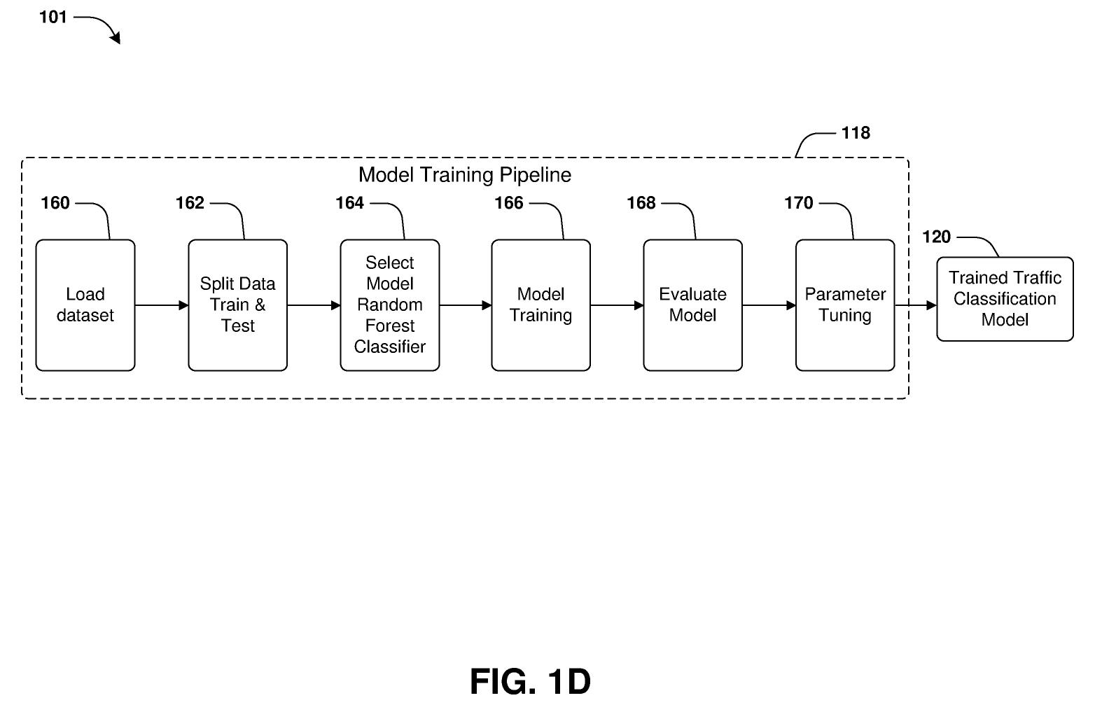

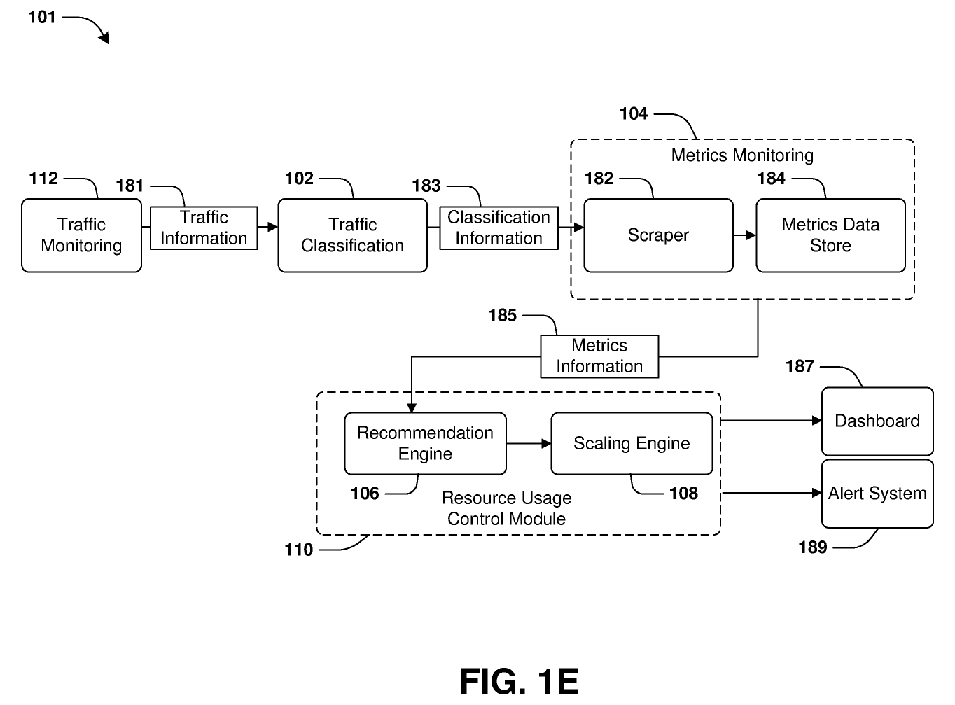

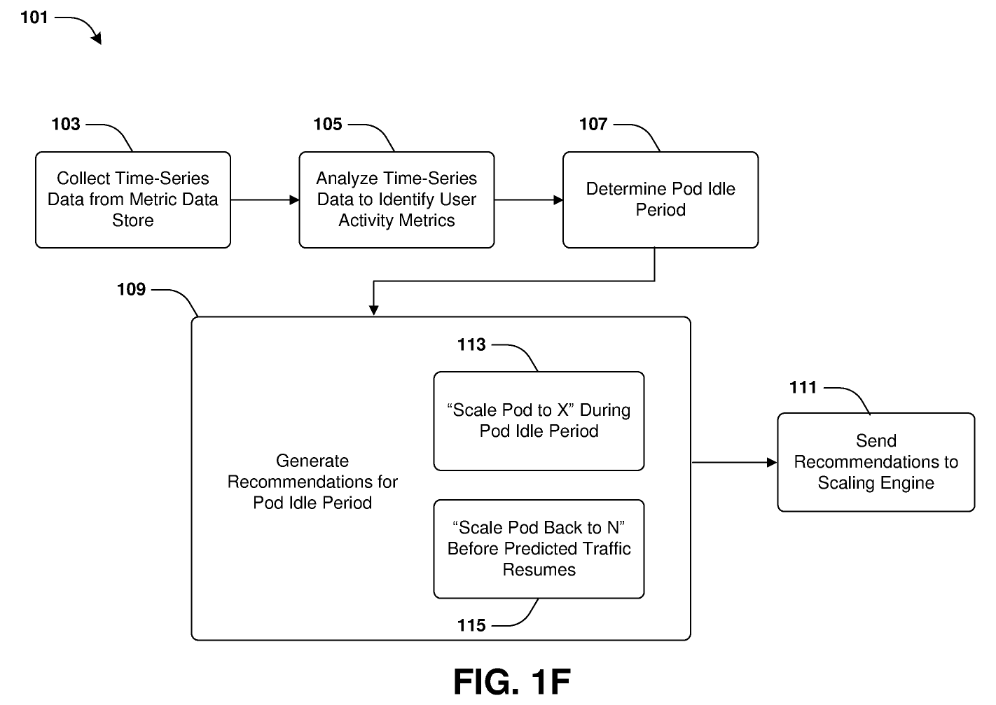

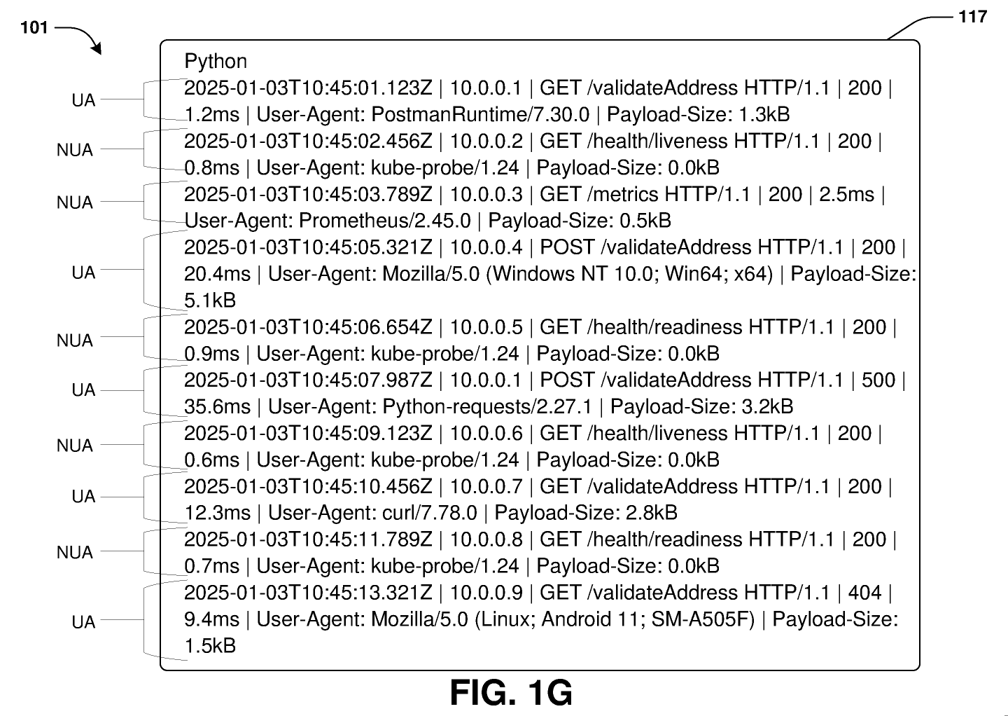

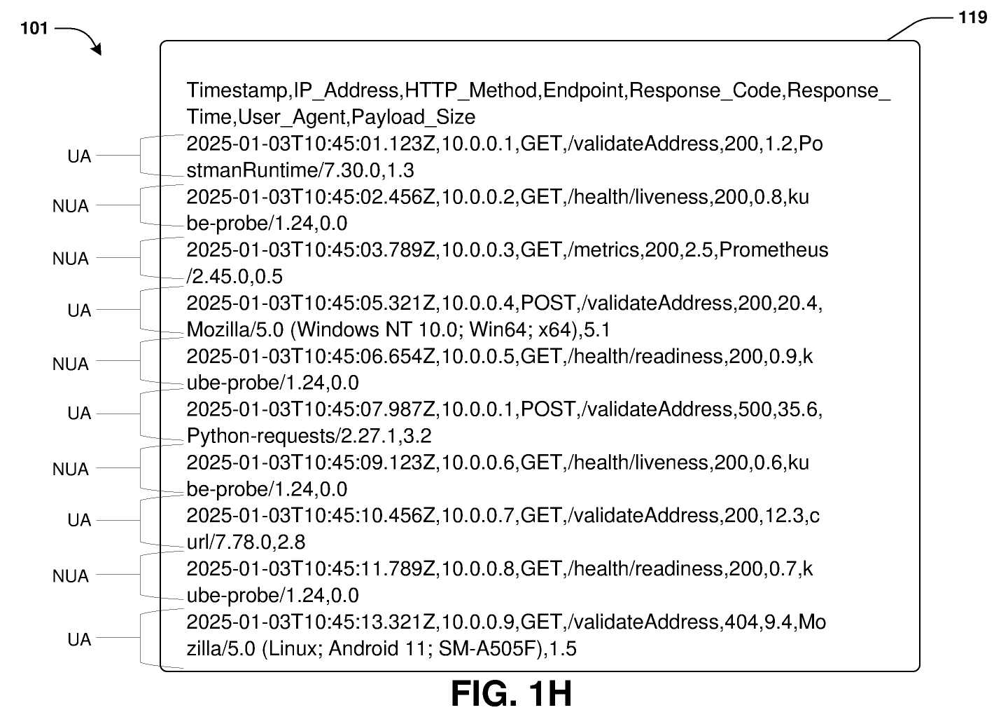

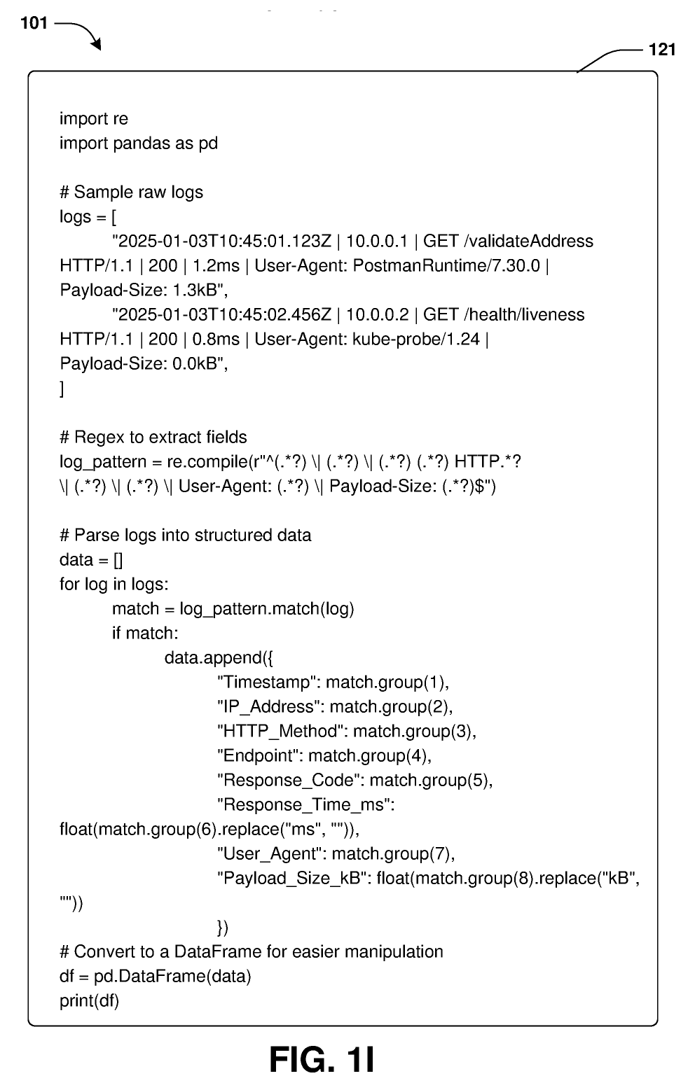

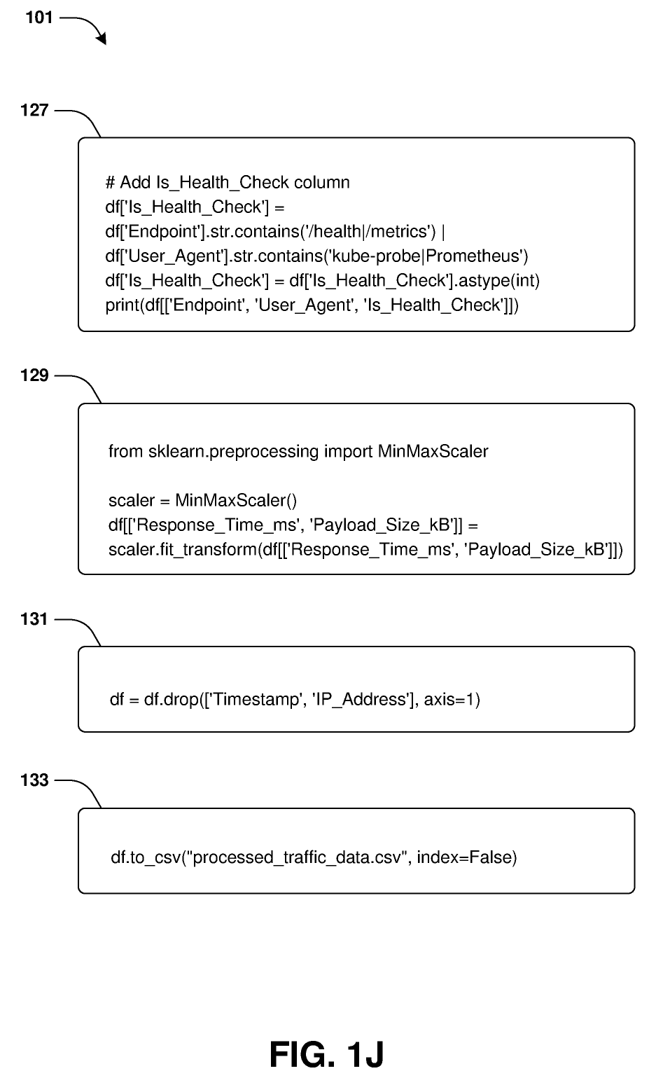

FIGS. 1A-1J illustrate examples of a system 101 for controlling resource usage of container pods. FIG. 1A illustrates components of the system 101 comprising a traffic monitoring module 112, a traffic classification module 102, a metrics monitoring module 104 and/or a resource usage control module 110. In some examples, the traffic monitoring module 112 may be configured to monitor for and/or identify traffic directed to a first container pod. The traffic monitoring module 112 may provide information indicative of the traffic to the traffic classification module 102. The traffic classification module 102 may be configured to determine traffic classifications for the traffic (based upon the information provided by the traffic monitoring module 112, for example). Each traffic classification of one, some or all of the traffic classifications may be indicative of whether a subset of the traffic is user activity traffic or non-user activity traffic. The traffic monitoring module 112 may provide the traffic classifications to the metrics monitoring module 104.

In some examples, the metrics monitoring module 104 may be configured to determine one or more traffic metrics associated with the first container pod based upon the traffic classifications. The metrics monitoring module 104 may provide the one or more traffic metrics to the resource usage control module 110. The resource usage control module 110 may be configured to control a first resource usage parameter associated with the first container pod based upon the one or more traffic metrics.

In some examples, the resource usage control module 110 may comprise a recommendation engine 106 and/or a scaling engine 108 (e.g., a scaling automation engine). The recommendation engine 106 may be configured to determine a recommendation based upon the one or more traffic metrics and/or provide the recommendation to the scaling engine 108. The scaling engine 108 may be configured to control the first resource usage parameter associated with the first container pod based upon the recommendation.

In some examples, the first container pod is hosted by a cluster of computers (e.g., a cluster of machines and/or working nodes). In some examples, a container orchestration platform (e.g., Kubernetes ®) manages a set of containers (e.g., containerized applications) via automated deployment, scaling and/or maintenance of the containers across the cluster of computers. For example, the container orchestration platform may provide one or more automated container management services, such as at least one of self-healing, scaling, rolling updates, etc. The first container pod may comprise (and/or host) one or more containers of the set of containers. In some examples, the one or more containers comprises a first container associated with a first application. In some examples, the first container pod may virtualize an operating system to allow more than one container to run on a single host (e.g., the one or more containers may comprise more than one container). The first container may comprise an executable program to run the first application and/or a runtime, one or more system tools, one or more libraries and/or one or more settings associated with the first application. The one or more containers in the first container pod may share one or more resources (e.g., networking resources, storage resources, etc.) of the first container pod. The first container may be generated (based upon a first container image, for example) using a container engine platform (e.g., Docker ®) comprising a container engine (e.g., Docker engine) for building and/or running the one or more containers and/or a container registry for storing and/or sharing images of the one or more containers (e.g., the first container may comprise a runtime instance of the first container image).

FIG. 1B illustrates generation of a trained traffic classification model 120 to be used by the traffic classification module 102 for determining traffic classifications of traffic. In some examples, the system 101 may comprise a traffic data collection module 114, a feature engineering module 116 and/or a model training pipeline 118. The traffic data collection module 114 may be configured to collect traffic data indicative of traffic directed to (e.g., incoming to) one or more container pods, such as the first container pod and/or one or more other container pods (e.g., one or more container pods hosted by the cluster of computers and/or a different cluster of computers). The feature engineering module 116 may be configured to determine (e.g., extract) features of the collected traffic data and/or provide the features to the model training pipeline 118. The model training pipeline 118 may train a machine learning model based upon the features to generate the trained traffic classification model 120.

FIG. 1C illustrates generation of training data 154 to provide to the model training pipeline 118. In some examples, the traffic data collection module 114 may comprise a data collector 140, a log data storage module 142, a log data store 146 and/or a log data parser 148. The data collector 140 may collect logged data from an environment 138 of the container orchestration platform and/or may provide (e.g., push and/or forward) the logged data to the log data storage module 142. The logged data may be indicative of traffic directed to one or more container pods. At least some of the logged data may be generated by one or more applications, services and/or system components running in the environment 138 (using the cluster of computers, for example). In some examples, the logged data may comprise one or more pod logs associated with one or more container pods, such as the first container pod and/or one or more other container pods. The logged data may be collected from one or more container pods, containers and/or computers associated with the cluster of computers. In some examples, the data collector 140 uses Fluentd and/or other data collector system to collect the logged data and/or provide (e.g., push and/or forward) the logged data to the log data storage module 142.

In some examples, the log data storage module 142 may be configured to store and/or query the logged data in a log data store 146 (e.g., a data store for logged data). In some examples, the log data store 146 may comprise a database (e.g., a non-relational database, such as an Elasticsearch ® database and/or other type of database). In some examples, the log data storage module 142 may comprise a distributed search and/or analytics engine (e.g., Elasticsearch engine and/or other type of engine) to query logged data stored in the log data store 146. In some examples, the log data storage module 142 may comprise a scheduler to export the logged data for storage in the log data store 146 periodically (and/or in an aperiodic manner). Alternatively and/or additionally, the log data storage module 142 may stream the logged data into the log data store 146 for storage. In some examples, the scheduler may export the logged data to the log data store 146 in an automated manner. In some examples, the log data parser 148 retrieves data (e.g., the logged data) stored in the log data store 146, and/or parses and/or structures the data (which may comprise unstructured data) to generate a structured data file 150. The structured data file 150 may be a file (e.g., Comma-Separated Values (CSV) file or other type of file) having a structured format (e.g., CSV format or other format).

In some examples, the traffic data collection module 114 may provide the structured data file 150 to a data pre-processing module 152 configured to process the structured data file 150 to generate the training data 154 for use in training the machine learning model. The data pre-processing module 152 may comprise the feature engineering module 116 to determine a set of features based upon the structured data file 150. The data pre-processing module 152 may generate the training data 154 based upon the set of features (e.g., the training data 154 may be indicative of the set of features).

In some examples, the training data 154 may comprise labeled data. The training data 154 may comprise structured data (e.g., a structured data file, such as a CSV file or other type of file) having a structured format (e.g., CSV format or other format). The training data 154 may be indicative of traffic and/or labels indicative of traffic classifications for the traffic. The labels may be determined using the feature engineering module 116. For example, the training data 154 may be indicative of one or more first features associated with a first set of traffic (e.g., one or more signals directed to one or more container pods hosted by the cluster of computers), a first label indicative of a first traffic classification of the first set of traffic, one or more second features associated with a second set of traffic (e.g., one or more signals directed to one or more container pods hosted by the cluster of computers) and/or a second label indicative of a second traffic classification of the second set of traffic. The one or more first features may comprise a first payload size (e.g., a size of a payload of the first set of traffic), a first response time (e.g., a time taken to process a request of the first set of traffic), a first endpoint (e.g., an endpoint and/or path of the request), a first user agent (e.g., a user-agent string provided by a client, which may be used to identify bots or browsers) and/or one or more other features associated with the first set of traffic. The first traffic classification may be indicative of whether the first set of traffic is user activity traffic or non-user activity traffic. The one or more second features may comprise a second payload size, a second response time, a second endpoint, a second user agent and/or one or more other features associated with the second set of traffic. The second traffic classification may be indicative of whether the second set of traffic is user activity traffic or non-user activity traffic.

In some examples, user activity traffic may comprise at least one of user-generated traffic, application-driven traffic, interactive traffic, operational traffic, end-user traffic, etc. In some examples, non-user activity traffic may comprise at least one of health check traffic (e.g., traffic associated with a general endpoint to check if a service is running), readiness check traffic (e.g., traffic to check if a container pod is ready to accept traffic), liveness check traffic (e.g., traffic to check if a container pod is alive and/or functioning properly), startup check traffic (e.g., traffic to check if an application has successfully started and/or is ready to initialize), metrics check traffic (e.g., traffic to provide metrics about performance and/or resource usage of an application), dependency check traffic (e.g., traffic to check a status of external dependencies), custom health check traffic (e.g., traffic for application-specific checks for one or more components, such as one or more components determined to be critical for the corresponding application), version check traffic (e.g., traffic to return a current version of an application), configuration check traffic (e.g., traffic to verify that an application configuration is correct and/or loaded properly), etc.

In some examples, one or more labels of the training data 154 may be generated via a supervised labeling process (e.g., the first traffic classification may be determined based upon an input received from an agent tasked with manually determining the first traffic classification, for example).

In some examples, one or more labels of the training data 154 may be generated automatically (in an unsupervised labeling process, for example). The data pre-processing module 152 may determine the first traffic classification based upon the first payload size, the first response time, the first endpoint, the first user agent and/or one or more other features associated with the first set of traffic.

For example, the data pre-processing module 152 may determine the first traffic classification to indicate non-user activity traffic based upon a determination that the first payload size is not greater than a threshold payload size (e.g., zero kilobytes), a determination that the first response time is not greater than a threshold response time, a determination that the first endpoint meets one or more first endpoint conditions, and/or a determination that the first user agent meets one or more first user agent conditions. The one or more first endpoint conditions may comprise a condition that the first endpoint comprises and/or begins with an endpoint term of one or more first endpoint terms (e.g., at least one of “/health”, “/metrics”, “/health/readiness”, “/health/liveness”, etc.). The one or more first user agent conditions may comprise a condition that the first user agent is indicative of a user agent of one or more first user agents (e.g., browser, Python script, Postman, etc.).

Alternatively and/or additionally, the data pre-processing module 152 may determine the first traffic classification to indicate user activity traffic based upon a determination that the first payload size is greater than the threshold payload size (e.g., zero kilobytes), a determination that the first response time is greater than the threshold response time, a determination that the first endpoint does not meet the one or more first endpoint conditions and/or does meet one or more second endpoint conditions, and/or a determination that the first user agent does not meet the one or more first user agent conditions and/or does meet one or more second user agent conditions. The one or more second endpoint conditions may comprise a condition that the first endpoint comprises and/or begins with an endpoint term of one or more second endpoint terms (e.g., “/validateAddress” and/or one or more other terms). The one or more second user agent conditions may comprise a condition that the first user agent is indicative of a user agent of one or more second user agents (e.g., kube-probe, Prometheus, etc.).

FIG. 1D illustrates operations of the model training pipeline 118 to generate the trained traffic classification model 120 based upon the training data 154. The model training pipeline 118 may include loading (e.g., importing and/or preparing), at 160, a training dataset from the training data 154 (e.g., the training dataset may comprise some or all of the training data 154). The model training pipeline 118 may include splitting (e.g., dividing and/or separating), at 162, the training dataset into a training subset and a testing subset. The model training pipeline 118 may include selecting, at 164, a machine learning model type (e.g., a machine learning algorithm) to be trained to determine traffic classifications of traffic. In some examples, the machine learning model type selected may be at least one of a tree-based classification model (e.g., a Random Forest classifier model or other tree-based classification model) or other type of machine learning model. The model training pipeline 118 may include training, at 166, the machine learning model (of the selected machine learning model type, for example) using the training subset, to generate a trained machine learning model (e.g., the training of act 166 may include learning patterns and/or relationships from the training subset). The model training pipeline 118 may include evaluating, at 168, the trained machine learning model using the testing subset to determine one or more performance metrics, such as at least one of accuracy, precision, error rate, etc. The model training pipeline 118 may include tuning, at 170, one or more parameters (e.g., one or more hyper-parameters, such as at least one of number of trees in a tree-based classification model, maximum depth, etc.) of the trained machine learning model to generate the trained traffic classification model 120 (e.g., a fine-tuned version of the trained machine learning model).

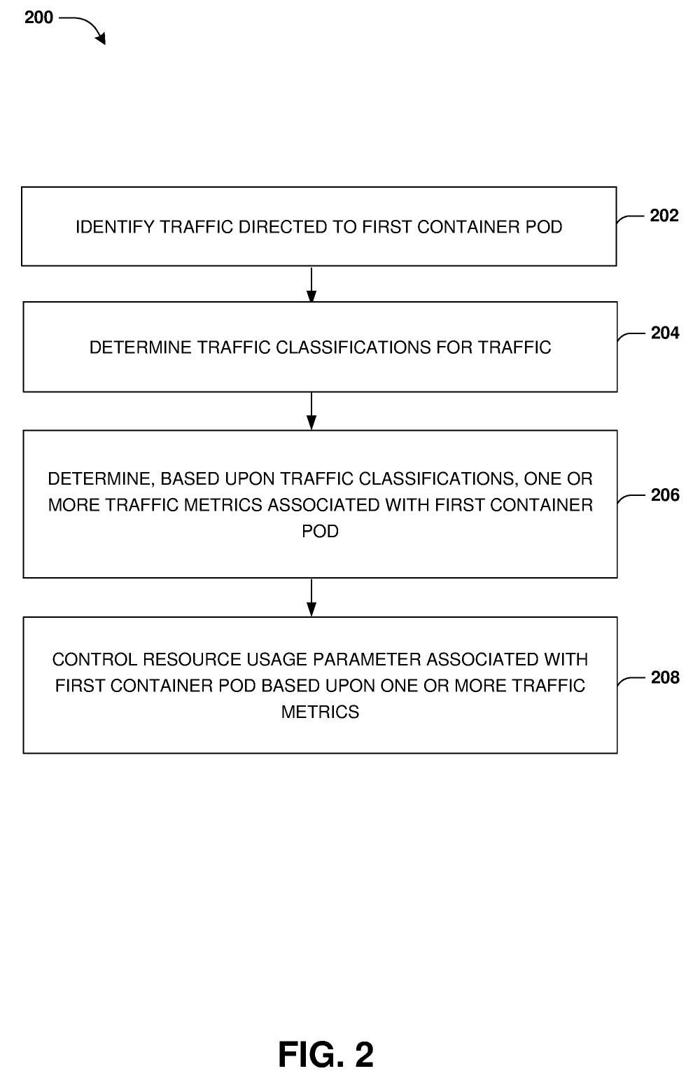

An embodiment of for controlling resource usage of container pods is illustrated by an exemplary method 200 of FIG. 2, and is further described in conjunction with the system 101 of FIGS. 1A-1J. FIG. 1E illustrates interactions between the traffic monitoring module 112, the traffic classification module 102, the metrics monitoring module 104 and/or the resource usage control module 110. At 202, the traffic monitoring module 112 may identify first traffic directed to (e.g., addressed to and/or incoming to) the first container pod. For example, the traffic monitoring module 112 may detect the first traffic while monitoring for traffic directed to the first container pod. The first traffic may comprise signals carrying at least one of information, one or more requests (e.g., Application Programming Interface (API) requests), etc. The traffic monitoring module 112 may provide traffic information 181 indicative of the first traffic to the traffic classification module 102. In some examples, the traffic monitoring module 112 may be deployed as a container (e.g., a sidecar container), such as a containerized service (e.g., a containerized microservice) which may be hosted by the cluster of computers. In some examples, the traffic monitoring module 112 may be deployed as a standalone service alongside container pods (e.g., container pods hosted by the cluster of computers).

At 204, the traffic classification module 102 may determine a set of traffic classifications for the first traffic. The traffic classification module 102 may determine the set of traffic classifications using the trained traffic classification model 120 (e.g., the trained traffic classification model 120 may be loaded into the traffic classification module 102 prior to determining the set of traffic classifications). Each traffic classification of one, some, or all of the set of traffic classifications is indicative of a whether a subset of the first traffic (e.g., a set of one or more signals directed to the first container pod) is user activity traffic or non-user activity traffic. For example, a subset of the first traffic may comprise one or more signals comprising a request (e.g., an API request) for a service provided by an application of the one or more containers hosted by the first container pod, such as a service of the first application. In some examples, the first container pod may be used to perform one or more operations associated with the service in response to the request for the service. For example, the set of traffic classifications may comprise a first traffic classification indicative of whether a first subset of traffic directed to the first container pod is user activity traffic or non-user activity traffic, a second traffic classification indicative of whether a second subset of traffic directed to the first container pod is user activity traffic or non-user activity traffic, etc.

In some examples, the traffic classification module 102 may be deployed as a container (e.g., a sidecar container), such as a containerized service (e.g., a containerized microservice) which may be hosted by the cluster of computers. In some examples, the traffic classification module 102 may be deployed as a standalone service alongside container pods (e.g., container pods hosted by the cluster of computers). The traffic classification module 102 may provide classification information 183 indicative of the set of traffic classifications to the metrics monitoring module 104. In some examples, the classification information 183 may be indicative of a user activity classification count (e.g., a quantity of classifications of the set of traffic classifications indicative of user activity traffic) and/or a non-user activity classification count (e.g., a quantity of classifications of the set of traffic classifications indicative of non-user activity traffic).

At 206, the metrics monitoring module 104 may determine a set of traffic metrics (e.g., a set of one or more traffic metrics) associated with the first container pod based upon the set of traffic classifications. For example, the set of traffic metrics may be indicative of a first user activity metric and/or a first non-user activity metric.

The first user activity metric may be indicative of a measure (e.g., a frequency, a count, an average, etc.) of user activity traffic (e.g., traffic, such as signals carrying API requests and/or other types of signals, classified as being user activity traffic), such as a count of user activity traffic subsets per unit of time. Alternatively and/or additionally, the first user activity metric may be indicative of a measure (e.g., a frequency, a count, an average, etc.) of user activity requests (e.g., requests, such as API requests and/or other types of requests, classified as being user activity traffic), such as a count of user activity requests per unit of time.

The first non-user activity metric may be indicative of a measure (e.g., a frequency, a count, an average, etc.) of non-user activity traffic (e.g., traffic, such as signals carrying API requests and/or other types of signals, classified as being non-user activity traffic), such as a count of non-user activity traffic subsets per unit of time. Alternatively and/or additionally, the first non-user activity metric may be indicative of a measure (e.g., a frequency, a count, an average, etc.) of non-user activity requests (e.g., requests, such as API requests and/or other types of requests, classified as being non-user activity traffic), such as a count of non-user activity requests per unit of time.

In some examples, the metrics monitoring module 104 may comprise a scraper 182 to determine the set of traffic metrics based upon the classification information 183 from the traffic classification module 102 and/or a metrics data store 184 to store the set of traffic metrics. In some examples, the scraper 182 may be deployed as a container (e.g., a sidecar container), such as a containerized service (e.g., a containerized microservice) which may be hosted by the cluster of computers. In some examples, the scraper 182 may be deployed as a standalone service alongside container pods (e.g., container pods hosted by the cluster of computers). In some examples, the metrics monitoring module 104 uses Prometheus and/or one or more other tools to determine the set of traffic metrics based upon the classification information 183 and/or to store the set of traffic metrics in the metrics data store 184 (e.g., a time-series database indicative of traffic metrics, such as user activity metrics and/or non-user activity metrics, at various times).

At 208, the resource usage control module 110 may control the first resource usage parameter associated with the first container pod based upon the set of traffic metrics. For example, the recommendation engine 106 may determine a first recommendation based upon the set of traffic metrics and/or may provide the first recommendation to the scaling engine 108. In some examples, the scaling engine 108 may control the first resource usage parameter based upon the first recommendation. The first recommendation may be indicative of a target resource usage parameter. The scaling engine 108 may set the first resource usage parameter to the target resource usage parameter (and/or a value determined based upon the target resource usage parameter) based upon the first recommendation.

A plurality of user activity metrics associated with a plurality of times may be stored in the metrics data store 184 over time (e.g., the plurality of user activity metrics may comprise user activity metrics associated with the first container pod at various times). The plurality of user activity metrics may comprise the first user activity metric and/or other user activity metrics associated with the first container pod. In some examples, the metrics monitoring module 104 may provide metrics information 185 indicative of user activity metrics of the plurality of user activity metrics to the resource usage control module 110. In some examples, the metrics information 185 may be indicative of time-series data indicative of user activity metrics (e.g., the plurality of user activity metrics) associated with the first container pod over time. For example, the recommendation engine 106 may access the metrics data store 184 to retrieve the metrics information 185. In some examples, the recommendation engine 106 (and/or the metrics monitoring module 104) may analyze (and/or combine and/or aggregate) metrics of the plurality of user activity metrics to determine one or more user activity patterns associated with the first container pod. The one or more user activity patterns may be indicative of a pod idle period, a pod active period, and/or a traffic spike period.

The pod idle period may correspond to a period of time in which user activity traffic (e.g., traffic classified as user activity traffic) directed to the first container pod is not greater than a threshold. For example, the pod idle period may be identified based upon a determination that one or more user activity metrics (e.g., the first user activity metric and/or one or more other user activity metrics of the plurality of user activity metrics) associated with one or more times during the pod idle period are not greater than a first threshold user activity metric. In some examples, the first threshold user activity metric may be zero (e.g., the pod idle period may correspond to a period in which traffic classified as user activity traffic is not directed the first container pod) or greater than zero (e.g., the pod idle period may correspond to a period in which little to no traffic classified as user activity traffic is directed the first container pod). In some examples, the pod idle period may correspond to a (predicted) time period in the future (e.g., a beginning and/or end of the pod idle period may be in the future). For example, the pod idle period may be identified based upon a determination (via a time-series analysis of user activity metrics of the plurality of user activity metrics, for example) that one or more predicted user activity metrics associated with one or more times during the pod idle period are not greater than the first threshold user activity metric.

In some examples, the resource usage control module 110 may control the first resource usage parameter associated with the first container pod based upon the pod idle period. For example, the resource usage control module 110 may modify (e.g., decrease), at a first time prior to or during the pod idle period, the first resource usage parameter to decrease an amount of resources allocated to the first container pod. The resource usage control module 110 may modify (e.g., increase), at a second time after the first time, the first resource usage parameter to increase the amount of resources allocated to the first container pod. The second time may be prior to, at the same time as, or after an end of the pod idle period. The recommendation engine 106 may determine a first resource usage parameter recommendation based upon the pod idle period and/or may provide the first resource usage parameter recommendation to the scaling engine 108. The first resource usage parameter recommendation may be indicative of a beginning time of the pod idle period and/or an end time of the pod idle period. Based upon the first resource usage parameter recommendation, the scaling engine 108 may set the first resource usage parameter to a first value at the first time (which may be determined based upon the beginning time of the pod idle period, for example), and/or set the first resource usage parameter to a second value at the second time (which may be determined based upon the end time of the pod idle period, for example). The second value may be greater than the first value. In some examples, the first value may be zero (e.g., the first resource usage parameter recommendation may be indicative of scale deployment to zero). In some examples, the first value may be greater than zero.

The pod active period may correspond to a period of time in which user activity traffic (e.g., traffic classified as user activity traffic) directed to the first container pod is greater than the threshold. For example, the pod active period may be identified based upon a determination that one or more user activity metrics (e.g., the first user activity metric and/or one or more other user activity metrics of the plurality of user activity metrics) associated with one or more times during the pod active period are greater than the first threshold user activity metric. In some examples, the pod active period may correspond to a (predicted) time period in the future (e.g., a beginning and/or end of the pod active period may be in the future). For example, the pod active period may be identified based upon a determination (via a time-series analysis of user activity metrics of the plurality of user activity metrics, for example) that one or more predicted user activity metrics associated with one or more times during the pod active period are greater than the first threshold user activity metric.

In some examples, the resource usage control module 110 may control the first resource usage parameter associated with the first container pod based upon the pod active period. For example, the resource usage control module 110 may modify (e.g., increase), at a third time prior to or during the pod active period, the first resource usage parameter to increase the amount of resources allocated to the first container pod. The resource usage control module 110 may modify (e.g., decrease), at a fourth time after the third time, the first resource usage parameter to decrease the amount of resources allocated to the first container pod. The fourth time may be prior to, at the same time as, or after an end of the pod active period. The recommendation engine 106 may determine a second resource usage parameter recommendation based upon the pod active period and/or may provide the second resource usage parameter recommendation to the scaling engine 108. The second resource usage parameter recommendation may be indicative of a beginning time of the pod active period and/or an end time of the pod active period. Based upon the second resource usage parameter recommendation, the scaling engine 108 may set the first resource usage parameter to a third value (which may be about equal to the second value, for example) at the third time (which may be determined based upon the beginning time of the pod active period, for example), and/or set the first resource usage parameter to a fourth value (which may be about equal to the first value, for example) at the fourth time (which may be determined based upon the end time of the pod active period, for example).

The traffic spike period may correspond to a period of time in which user activity traffic (e.g., traffic classified as user activity traffic) directed to the first container pod is greater than a second threshold greater than the threshold. For example, the traffic spike period may be identified based upon a determination that one or more user activity metrics (e.g., the first user activity metric and/or one or more other user activity metrics of the plurality of user activity metrics) associated with one or more times during the traffic spike period are greater than a second threshold user activity metric. The second threshold user activity metric may be greater than the first threshold user activity metric. In some examples, the traffic spike period may correspond to a (predicted) time period in the future (e.g., a beginning and/or end of the traffic spike period may be in the future). For example, the traffic spike period may be identified based upon a determination (via a time-series analysis of user activity metrics of the plurality of user activity metrics, for example) that one or more predicted user activity metrics associated with one or more times during the traffic spike period are greater than the second threshold user activity metric.

In some examples, the resource usage control module 110 may control the first resource usage parameter associated with the first container pod based upon the traffic spike period. For example, the resource usage control module 110 may modify (e.g., increase), at a fifth time prior to or during the traffic spike period, the first resource usage parameter to increase the amount of resources allocated to the first container pod. The resource usage control module 110 may modify (e.g., decrease), at a sixth time after the fifth time, the first resource usage parameter to decrease the amount of resources allocated to the first container pod. The sixth time may be prior to, at the same time as, or after an end of the traffic spike period. The recommendation engine 106 may determine a third resource usage parameter recommendation based upon the traffic spike period and/or may provide the third resource usage parameter recommendation to the scaling engine 108. The second resource usage parameter recommendation may be indicative of a beginning time of the traffic spike period and/or an end time of the traffic spike period. Based upon the third resource usage parameter recommendation, the scaling engine 108 may set the first resource usage parameter to a fifth value (which may be greater than the second value and/or the third value, for example) at the fifth time (which may be determined based upon the beginning time of the traffic spike period, for example), and/or set the first resource usage parameter to a sixth value (which may be about equal to the first value or the third value, for example) at the sixth time (which may be determined based upon the end time of the traffic spike period, for example). In some examples, the fifth value may correspond to a traffic spike value for traffic spike periods of the first container pod. For example, the traffic spike value may be a predefined value (which may be modifiable by the recommendation engine 106 and/or the scaling engine 108, for example) that the recommendation engine 106 and/or the scaling engine 108 are configured to set the first resource usage parameter to during traffic spike periods of the first container pod.

In some examples, the first resource usage parameter corresponds to a replica count of the first container pod in the cluster of computers hosting the first container pod. The replica count may be indicative of a target quantity of computers (e.g., a quantity of working nodes), of the cluster of computers (e.g., the cluster of working nodes), that are allocated to running replicas (e.g., identical copies) of the first container pod. Alternatively and/or additionally, the replica count may be indicative of a target quantity of replicas of the first container pod to be running in the cluster of computers. In a scenario in which the first resource usage parameter is five, the container orchestration platform may manage the cluster of computers such that five computers in the cluster of computers are allocated for running replicas of the first container pod (and/or about five replicas of the first container pod may be running based upon the first resource usage parameter being set to five).

In some examples, the recommendation engine 106 may comprise a second trained machine learning model to determine one or more recommendations (e.g., at least one of the first resource usage parameter recommendation, the second resource usage parameter recommendation, the third resource usage parameter recommendation, etc.) based upon metrics information (e.g., the metrics information 185) from the metrics monitoring module 104. A second machine learning model (e.g., a long short-term memory (LSTM) network and/or other type of machine learning model) may be trained using a second training dataset to generate the second trained machine learning model. The second training dataset may be indicative of user activity metrics and/or labels (e.g., recommendations corresponding to ground truth information) associated with the user activity metrics.

In some examples, performance information associated with performance of the cluster of computers may be recorded by a performance monitoring module of the system 101. The performance information may be indicative of memory usage of the cluster of computers to host the first container pod, processor usage of the cluster of computers to host the first container pod, response time of the first container pod, a throughput associated with the first container pod, a pod restart rate, etc. In some examples, the performance information may be used as feedback to update (e.g., fine-tune) the second trained machine learning model (e.g., one or more tunable parameters of the second trained machine learning model may be modified based upon the feedback to more accurately determine recommendations that result in improved performance of the cluster of computers and/or the first container pod). It may be appreciated that updating the second trained machine learning model based upon the performance information may create a closed-loop process allowing results of recommendations and/or scaling actions to be used as feedback to tailor parameters of the second trained machine learning model. Closed-loop control may reduce errors and produce more efficient operation of a computer system which implements the second trained machine learning model and/or the cluster of computers. The reduction of errors and/or the efficient operation of the computer system may improve operational stability and/or predictability of operation. Accordingly, using processing circuitry to implement closed loop control described herein may improve operation of underlying hardware of the computer system.

FIG. 1F illustrates operations of the recommendation engine 106 to determine one or more recommendations associated with the first container pod. The operations of the recommendation engine 106 may include collecting, at 103, time-series data (e.g., the metrics information 185) from the metrics data store 184. The operations of the recommendation engine 106 may include analyzing, at 105, the time-series data (using a rule-based engine, for example) to identify user activity patterns associated with the first container pod, such as patterns across user activity metrics of the plurality of user activity metrics. The operations of the recommendation engine 106 may include determining, at 107, the pod idle period (e.g., extended periods of zero user activity traffic or near-zero user activity traffic) associated with the first container pod based upon the user activity patterns. The operations of the recommendation engine 106 may include generating, at 109, one or more recommendations for the first container pod for the pod idle period. The operations of the recommendation engine 106 may include sending, at 111, the one or more recommendations for the first container pod to the scaling engine 108. The one or more recommendations may comprise a recommendation 113 to scale instances (e.g., replicas) of the first container pod to X (e.g., the first value, which may be zero or greater than zero) during the pod idle period. The one or more recommendations may comprise a recommendation 115 to scale instances (e.g., replicas) of the first container pod to N (e.g., N may correspond to the second value and/or the third value) before the end of the pod idle period (e.g., at a time before user activity traffic is predicted to resume in a subsequent pod active period after the pod idle period).

In some examples, N (e.g., the second value and/or the third value) may correspond to a pod active value for pod active periods of the first container pod. For example, the pod active value may be a predefined value (which may be modifiable by the recommendation engine 106 and/or the scaling engine 108, for example) that the recommendation engine 106 and/or the scaling engine 108 are configured to set the first resource usage parameter to during pod active periods of the first container pod. In some examples, X (e.g., the first value) may correspond to a pod idle value for pod idle periods of the first container pod. For example, the pod idle value may be a predefined value (which may be modifiable by the recommendation engine 106 and/or the scaling engine 108, for example) that the recommendation engine 106 and/or the scaling engine 108 are configured to set the first resource usage parameter to during pod idle periods of the first container pod.

In some examples, X (e.g., the first value) may correspond to a pod idle value for pod idle periods of the first container pod. For example, the pod idle value may be a predefined value (which may be modifiable by the recommendation engine 106 and/or the scaling engine 108, for example) that the recommendation engine 106 and/or the scaling engine 108 are configured to set the first resource usage parameter to during pod idle periods of the first container pod.

In some examples, the scaling engine 108 may comprise an auto-scaling module, such as an event-driven auto-scaling module (e.g., Kubernetes Event-Driven Autoscaling (KEDA) and/or other event-driven auto-scaling module). The scaling engine 108 may dynamically adjust the first resource usage parameter (and/or the replica count corresponding to the first resource usage parameter) based upon one or more recommendations (e.g., at least one of the first resource usage parameter recommendation, the second resource usage parameter recommendation, the third resource usage parameter recommendation, the recommendation 113, the recommendation 115, etc.) from the recommendation engine 106. In some examples, the scaling engine 108 may use a Horizontal Pod Autoscaler (HPA) configured to adjust the first resource usage parameter (and/or the replica count corresponding to the first resource usage parameter) based upon the one or more recommendations.

In some examples, based upon a recommendation (e.g., the recommendation 113) being indicative of decreasing (e.g., scaling down) instances (e.g., replicas) of the first container pod from the pod active value N to the pod idle value X for a pod idle period, the scaling engine 108 may scale down (upon and/or after a beginning of the pod idle period) replicas of the first container pod to the pod idle value X (e.g., zero) via graceful shutdown (e.g., ensuring that active requests and/or tasks are completed prior to terminating the first container pod). In some examples, based upon a recommendation (e.g., the recommendation 115) being indicative of increasing (e.g., scaling up) instances (e.g., replicas) of the first container pod from the pod idle value X to the pod active value N for a pod active period after the pod idle period, the scaling engine 108 may scale up replicas of the first container pod to the pod active value N via graceful recovery. For example, the first container pod may be scaled up during a warm-up period prior to the end of the pod idle period to initialize replicas of the first container pod prior to a beginning of the pod active period (such that the replicas of the first container pod are ready to handle requests when the pod active period starts and/or to avoid delays in handling the requests).

In some examples, the first container pod and/or the cluster of computers may operate in one or more types of environments, such as at least one of a development environment (for building and/or testing code of an application hosted by the first container pod, for example), a test environment (for automated and/or manual testing of an application hosted by the first container pod, for example), a SIT environment, a UAT environment, a PTE, etc., utilization of the first container pod and/or the cluster of computers by users (e.g., developers, testers, etc.) may vary throughout the day and/or week. For example, the resources usage control module 110 may identify (via a time-series analysis of user activity metrics of the plurality of user activity metrics, for example) pod active periods on work days (e.g., non-holiday weekdays) during office hours (e.g., 9:00AM to 6:00PM), pod idle periods after office hours on workdays (e.g., 6:00PM in the evening to 9:00AM the next morning), and/or pod idle periods during weekends. Accordingly, the resource usage control module 110 may set the first resource usage parameter to the pod active value during office hours (e.g., 9:00AM to 6:00PM). The resource usage control module 110 may set the first resource usage parameter to the pod idle value after office hours and/or during weekends. In some examples, prior to a pod active period, such as at about 8:30AM prior to the beginning (e.g., 9:00AM) of office hours of a workday, the first container pod may be pre-warmed (based upon ML predictions, for example) to handle incoming traffic from users (e.g., developers, testers, etc.).

In some examples, the first container pod and/or the cluster of computers may operate in a telecommunications environment associated with a telecom service provider (e.g., 5G-enabled telecom service provider). For example, a container of the first container pod may provide a service (e.g., address validation service) to verify subscriber locations in real-time for billing and/or fraud prevention. For example, the resources usage control module 110 may identify (via a time-series analysis of user activity metrics of the plurality of user activity metrics, for example) pod idle periods associated with the first container pod at nighttime (e.g., between 1:00AM and 9:00AM), and may set the first resource usage parameter to the pod idle value during the pod idle periods, which may provide significant cost savings, especially in regions with fluctuating traffic (e.g., business districts at night).

In some examples, the resource usage control module 110 may provide information indicative of traffic trends, identified pod idle periods, identified pod active periods and/or identified traffic spike periods to a dashboard 187 (shown in FIG. 1E) and/or an alert system 189. The dashboard 187 may display a graphical object that visualizes the traffic trends, the identified pod idle periods, the identified pod active periods and/or the identified traffic spike periods. The dashboard 187 may be used to manually control the first resource usage parameter. The alert system 189 may be configured to provide alerts in response to detecting a traffic anomaly and/or a pod idle period that exceeds a threshold duration of time.

FIG. 1G illustrates a data structure 117 comprising at least some of the logged data collected by the data collector 140 (shown in FIG. 1C). Subsets of the data structure 117 that correspond to user activity traffic are labeled “UA”. Subsets of the data structure 117 that correspond to non-user activity traffic are labeled “NUA”. FIG. 1H illustrates a data structure 119 comprising at least some of the structured data file 150 generated by the traffic data collection module 114. Subsets of the data structure 119 that correspond to user activity traffic are labeled “UA”. Subsets of the data structure 119 that correspond to non-user activity traffic are labeled “NUA”. FIG. 1I illustrates a program 121 run by the log data parser 148 to generate the structured data file 150. FIG. 1J illustrates programs 127, 129, 131 and 133. Programs 127, 129, 131 and/or 133 may be run by the data pre-processing module 152 to generate the training data 154.

In some examples, the system 101 may be used for optimizing resource utilization of the container orchestration platform across a plurality of environments (e.g., development environment, test environment, SIT environment, UAT environment, etc.). The system may aggregate classified traffic metrics (e.g., the plurality of user activity metrics) for environment-specific analysis to determine environment-specific usage patterns. Pod idle period recommendations (e.g., the first resource usage parameter recommendation) may be dynamically adjusted based upon the environment-specific usage patterns. Scaling policies (employed by the scaling engine 108) may be automatically tailored to requirements of a corresponding environment. For example, the system may recommend scaling down pods in the development environment during weekends when no development activity is expected.

In some examples, the system 101 may be used for implementing pod scaling integrated with an event-driven auto-scaler (e.g., KEDA), such as by generating custom metrics (e.g., the plurality of user activity metrics) from classified traffic data stored in Prometheus, configuring a scaling configuration (e.g., a KEDA ScaledObject and/or other autoscaling configuration) based upon the custom metrics, triggering pod scaling actions based upon thresholds derived from the classified traffic data (e.g., the thresholds may be determined based upon the scaling configuration), and/or restoring an original pod configuration (e.g., setting the first resource usage parameter to the pod active value) in response to detection of user activity traffic.

In some examples, the scaling configuration may be indicative of a start time at which to initiate pod scaling to zero for a pod idle period, and/or an end time at which to restore the original pod configuration (e.g., set the first resource usage parameter to the pod active value), which may be based upon return of user activity traffic. n some examples, the traffic classification module 102 may be integrated with one or more native logging and/or monitoring tools, such as at least one of Fluentd, Prometheus, etc. to provide seamless integration with the container orchestration platform.

In some examples, recommendations (e.g., pod scaling recommendations, such as at least one of the first resource usage parameter recommendation, the second resource usage parameter recommendation, etc.) may be delivered (by the recommendation engine 106 to the scaling engine 108 and/or the dashboard 187 and/or the alert system 189, for example) via an API (e.g., Representational State Transfer (REST) API) to allow tools (e.g., external tools such as at least one of the scaling engine 108, the dashboard 187, the alert system 189 and/or one or more other tools) to be integrated and/or to effectively act on the recommendations. In some examples, the scaling engine 108 is an external tool of the system 101 or an internal tool of the system 101.

In some examples, each machine learning model of one, some and/or all of the machine learning models herein (e.g., the trained traffic classification model 120, the second trained machine learning model, etc.) may comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

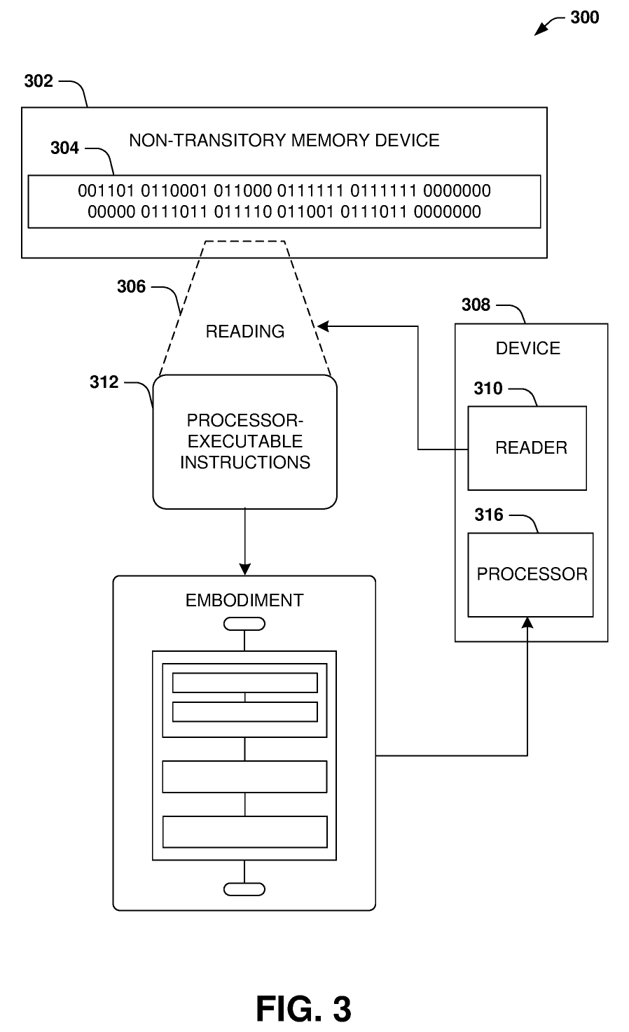

FIG. 3 is an illustration of a scenario 300 involving an example non-transitory machine readable medium 302. The non-transitory machine readable medium 302 may comprise processor-executable instructions 312 that when executed by a processor 316 cause performance (e.g., by the processor 316) of at least some of the provisions herein. The non-transitory machine readable medium 302 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 302 stores computer-readable data 304 that, when subjected to reading 306 by a reader 310 of a device 308 (e.g., a read head of a hard disk drive, or a read operation invoked on a solid-state storage device), express the processor-executable instructions 312. In some embodiments, the processor-executable instructions 312, when executed cause performance of operations, such as at least some of the example method 200 of FIG. 2, for example. In some embodiments, the processor-executable instructions 312 are configured to cause implementation of a system, such as at least some of the example system 101 of FIGS. 1A-1J, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, "component," "module," "system", "interface", and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, "example" is used herein to mean serving as an example, instance, illustration, etc., and not necessarily as advantageous. As used herein, "or" is intended to mean an inclusive "or" rather than an exclusive "or". In addition, "a" and "an" as used in this application are generally be construed to mean "one or more" unless specified otherwise or clear from context to be directed to a singular form. Also, at least one of A and B and/or the like generally means A or B or both A and B. Furthermore, to the extent that "includes", "having", "has", "with", and/or variants thereof are used in either the detailed description or the claims, such terms are intended to be inclusive in a manner similar to the term "comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
identifying traffic directed to a first container pod;
determining traffic classifications for the traffic, wherein each traffic classification is indicative of whether a subset of the traffic is user activity traffic or non-user activity traffic;
determining, based upon the traffic classifications, one or more traffic metrics associated with the first container pod; and
controlling a resource usage parameter associated with the first container pod based upon the one or more traffic metrics.

2. The method of claim 1, wherein controlling the resource usage parameter comprises:
determining, based upon the one or more traffic metrics, a pod idle period associated with the first container pod; and
modifying, at a first time prior to or during the pod idle period, the resource usage parameter to decrease an amount of resources allocated to the first container pod.

3. The method of claim 2, wherein controlling the resource usage parameter comprises:
modifying, at a second time after the first time, the resource usage parameter to increase the amount of resources allocated to the first container pod.

4. The method of claim 1, wherein controlling the resource usage parameter comprises:
determining a first resource usage parameter recommendation based upon the one or more traffic metrics; and
transmitting an indication of the first resource usage parameter recommendation to a scaling engine configured to control the resource usage parameter.

5. The method of claim 1, wherein controlling the resource usage parameter comprises:
determining, based upon the one or more traffic metrics, a pod idle period associated with the first container pod;
determining a first resource usage parameter recommendation based upon the pod idle period; and
transmitting an indication of the first resource usage parameter recommendation to a scaling engine configured to control the resource usage parameter.

6. The method of claim 1, wherein controlling the resource usage parameter comprises:
determining, based upon the one or more traffic metrics, a pod active period associated with the first container pod;
determining a first resource usage parameter recommendation based upon the pod active period; and
transmitting an indication of the first resource usage parameter recommendation to a scaling engine configured to control the resource usage parameter.

7. The method of claim 1, wherein controlling the resource usage parameter comprises:
determining, based upon the one or more traffic metrics, a traffic spike period associated with the first container pod;
determining a first resource usage parameter recommendation based upon the traffic spike period; and
transmitting an indication of the first resource usage parameter recommendation to a scaling engine configured to control the resource usage parameter.

8. The method of claim 1, wherein:
the resource usage parameter corresponds to a replica count of the first container pod in a cluster of computers hosting the first container pod.

9. The method of claim 1, comprising:
prior to determining the traffic classifications of the traffic, collecting data indicative of traffic directed to one or more container pods; and
training a machine learning model using the data to generate a trained machine learning model, wherein the traffic classifications are determined using the trained machine learning model.

10. A system, comprising:
a traffic monitoring module configured to identify traffic directed to a first container pod;
a traffic classification module configured to determine traffic classifications for the traffic, wherein each traffic classification is indicative of whether a subset of the traffic is user activity traffic or non-user activity traffic;
a metrics monitoring module configured to determine one or more traffic metrics associated with the first container pod based upon the traffic classifications; and
a resource usage control module configured to control a resource usage parameter associated with the first container pod based upon the one or more traffic metrics.

11. The system of claim 10, wherein the resource usage control module comprises at least one of:
a recommendation engine configured to determine a first resource usage parameter recommendation based upon the one or more traffic metrics; or
a scaling engine configured to control the resource usage parameter based upon the first resource usage parameter recommendation.

12. The system of claim 10, wherein:
the resource usage parameter corresponds to a replica count of the first container pod in a cluster of computers hosting the first container pod.

13. The system of claim 10, comprising:
a training module configured to:
collect training data indicative of traffic directed to one or more container pods; and
train a machine learning model using the training data to generate a trained machine learning model, wherein the traffic classification module comprises the trained machine learning model.

14. A non-transitory computer-readable medium storing instructions that when executed perform operations comprising:
identifying traffic directed to a first container pod;
determining traffic classifications for the traffic, wherein each traffic classification is indicative of whether a subset of the traffic is user activity traffic or non-user activity traffic;
determining, based upon the traffic classifications, one or more traffic metrics associated with the first container pod; and
controlling a resource usage parameter associated with the first container pod based upon the one or more traffic metrics.

15. The non-transitory computer-readable medium of claim 14, wherein controlling the resource usage parameter comprises:
determining, based upon the one or more traffic metrics, a pod idle period associated with the first container pod; and
modifying, at a first time prior to or during the pod idle period, the resource usage parameter to decrease an amount of resources allocated to the first container pod.

16. The non-transitory computer-readable medium of claim 15, wherein controlling the resource usage parameter comprises:
modifying, at a second time after the first time, the resource usage parameter to increase the amount of resources allocated to the first container pod.

17. The non-transitory computer-readable medium of claim 14, wherein controlling the resource usage parameter comprises:
determining a first resource usage parameter recommendation based upon the one or more traffic metrics; and
transmitting an indication of the first resource usage parameter recommendation to a scaling engine configured to control the resource usage parameter.

18. The non-transitory computer-readable medium of claim 14, wherein controlling the resource usage parameter comprises:
determining, based upon the one or more traffic metrics, a pod idle period associated with the first container pod;
determining a first resource usage parameter recommendation based upon the pod idle period; and
transmitting an indication of the first resource usage parameter recommendation to a scaling engine configured to control the resource usage parameter.

19. The non-transitory computer-readable medium of claim 14, wherein controlling the resource usage parameter comprises:
determining, based upon the one or more traffic metrics, a pod active period associated with the first container pod;
determining a first resource usage parameter recommendation based upon the pod active period; and
transmitting an indication of the first resource usage parameter recommendation to a scaling engine configured to control the resource usage parameter.

20. The non-transitory computer-readable medium of claim 14, wherein controlling the resource usage parameter comprises:
determining, based upon the one or more traffic metrics, a traffic spike period associated with the first container pod;
determining a first resource usage parameter recommendation based upon the traffic spike period; and
transmitting an indication of the first resource usage parameter recommendation to a scaling engine configured to control the resource usage parameter.
